(19) United States
(12) Patent Application Publication
(10) Pub. No.: US 2016/0235109 A1
(43) Pub. Date: Aug. 18, 2016

(54) Apparatus and Method for Drying and/or Treating Loose Food Products

(71) Applicant: Stalam S.p.A., Nove (Vicenza) (IT)

(72) Inventor: Manlio CAVESTRO, Nove (Vicenza) (IT)

(21) Appl. No.: 15/024,934

(22) PCT Filed: Nov. 15, 2013
(86) PCT No.: PCT/IB2013/060155

§ 371 Date: Mar. 25, 2016

(30) Foreign Application Priority Data
Sep. 27, 2013 (IT) VR2013A000220

(51) Int. Cl. A23L 3/01; A23L 3/54; A23L 3/18

(52) U.S. Cl. CPC A23L 3/01; A23L 3/185; A23L 3/54; A23V 2002/00

(57) ABSTRACT

An apparatus and a method of drying and/or treating loose products such as food products, for example corn, flour, seeds in general, spices, tea and coffee, dried pulses, dried or shelled fruit, like hazelnuts, dry food products in general, such as dried mushrooms, etcetera, the treatment which the aforementioned loose products can be subjected to being of the type such as disinfestation, sanitization, pasteurisation, sterilisation, etcetera, wherein the aforementioned apparatus comprises a conveyor for the loose products, a treatment unit defining a treatment chamber, means for generating radio frequency electromagnetic radiation, means for applying radio frequency electromagnetic radiation and/or microwaves which act in the treatment chamber or area and designed to affect the loose products transported through the treatment chamber or area, mixing means for the loose products to be treated arranged in the treatment chamber.

### TECHNICAL FIELD OF THE INVENTION

The present invention concerns an apparatus and a method for drying and/or treating loose products, such as: food products, for example corn, flour, seeds in general, spices, tea and coffee, dried pulses, dried fruit or fruit without shell, like hazelnuts, peanuts, almonds, dry products in general, such as dried mushrooms, tobacco, medicinal herbs, etc., the aforementioned loose products being subjectable to a treatment such as disinfestation, sanitization, pasteurisation, sterilisation, etc.

### STATE OF THE ART

To date, many apparatuses for treating loose food products in general have been proposed.

Indeed, if products like those listed above are not suitably treated, may happen that they are packaged with insects or microorganisms therein and/or as the case maybe, they are not adequately dried, disinfested, sanitized, pasteurised or sterilised.

Of course, these problems cause a low quality end product, which is not satisfactory for the end consumer, and/or deteriorates quickly during storing and/or is even harmful for the health of the consumer and therefore this results in the need of discarding and eliminating such products.

Another drawback due to the incorrect treatments of the aforementioned products is given by the excessive loss of humidity, which can indeed cause the products to deteriorate: even in this case a poor organoleptic quality of the products is obtained.

Moreover, due to the undesired loss of humidity, also a proportional loss of weight with consequent lower economic value of the products themselves is obtained.

It has already been proposed to treat food products with a radio frequency or microwave heating, such a treatment, especially for the products with a high water content, ensuring an optimal heat efficiency, since in a short time (also a few seconds) very high temperatures both at the surface of the foods and inside them can be obtained, thereby eliminating the microorganisms therein contained. The high heating speed makes it possible to pasteurise the products without causing them to be cooked.

U.S. Pat. No. 4,974,503 teaches, for example, an apparatus for pasteurizing and/or sterilising food products comprising a treatment chamber, a conveyor belt, located inside the chamber, rollers for actuating the conveyor belt and a mechanism for guiding the rollers. The products to be treated are located in containers laid on the conveyor belt. Moreover, electrodes and counter-electrodes are provided for inside the treatment chamber, which are arranged to set up a station for the electromagnetic radiation of the products with an electromagnetic field frequency ranging between 13 and 440 MHz.

U.S. Pat. No. 6,638,475 on the other hand describes a method and a system for applying a radio frequency electromagnetic field to a product, such as for example a base farm product, in order to inhibit the presence of pathogenic or spoilage agents in it.

The applied radio frequency radiation ranges between 0.1 MHz and 1000 MHz and has a low intensity, thereby determining a hostile environment for the pathogenic agents, following a localised heating of the product itself.

However, the solutions proposed so far, among all also the apparatuses and the methods according to the US patents commented above, do not make it possible to obtain in an efficient, controlled and homogeneous manner, or according to the needs a drying and/or treatment of the loose products, such as disinfestation, sanitization, pasteurisation, sterilisation etc..

Indeed, with the machines of the known type operating with radio frequency or microwaves, the aforementioned loose products cannot be correctly dried and/or treated.

The mass of loose products can be substantially different from one area to another of the mass itself: in one area the loose product can be too dry, whereas in other areas the loose products can still be still too humid and/or not sufficiently treated.

Moreover, due to the residual humidity, in the mass of loose products, lumps or agglomerations of product can be formed that prevent the products themselves from moving forward in the correct manner.

### SUMMARY OF THE INVENTION

One object of the present invention is to provide a new improved apparatus or a new improved method of drying and/or treating, such as disinfesting, sanitizing, pasteurising and sterilising loose food products.

Another object of the present invention is that of providing an apparatus or a method as mentioned above that is capable of carrying out the drying and/or the treatment, such as the disinfestation, sanitization, pasteurisation and sterilisation of loose products in a rapid, effective and homogeneous manner.

In accordance with one aspect of the invention an apparatus according to the present principles is provided.

In accordance with another aspect of the invention a method according to the present principles is provided.

The present application refers to preferred and advantageous embodiments of the invention.

### BRIEF DESCRIPTION OF THE DRAWINGS

Other features and advantages of the invention shall become clearer from the description of an embodiment of an apparatus according to the present invention, illustrated as an indication in the attached drawings, in which:

FIG. 1 is a front perspective view of an apparatus according to the present invention with some parts removed;

FIG. 2 is a perspective view of some enlarged details according to the previous figure;

FIG. 3 is a side perspective view of the apparatus according to the previous figures with parts removed;

FIG. 4 is a view from above of the apparatus according to the previous figures with some parts in section and other parts removed;

FIG. 5 is a perspective view of another version of the apparatus according to the present invention; and

FIG. 6 is a side view with some parts in section of the apparatus according to the previous figure; and

FIGS. 7 and 8 are two section views of some enlarged details of two versions of the apparatus according to the previous figure.

In the attached drawings same parts or components have the same reference numeral.

### DETAILED DESCRIPTION OF THE INVENTION

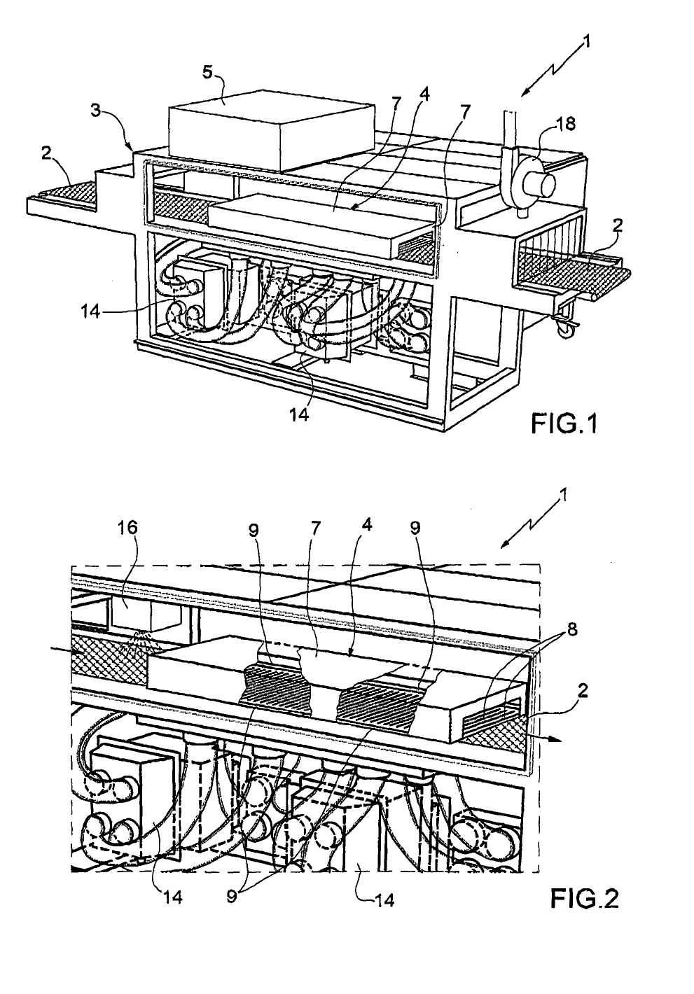

With reference to FIGS. 1-4, an apparatus 1 for drying and/or treating, such as disinfesting, sanitizing, pasteurising, sterilising, etc. loose products is shown.

The apparatus 1 essentially comprises transporting means for transporting the loose products, for example a conveyor belt 2, optionally equipped with vibrating means or other means that are suitable for mixing products as will be better described hereinafter, a treatment unit 3 delimiting one or more treatment chambers or areas 4 crossed by the conveyor belt 2, generator means 5 for generating radio frequency electromagnetic radiations and/or microwaves as well as means for applying radio frequency electromagnetic radiations and/or microwaves, which are not illustrated in the drawings, which act in the treatment chamber or area and are in electrical communication with the generator means 5.

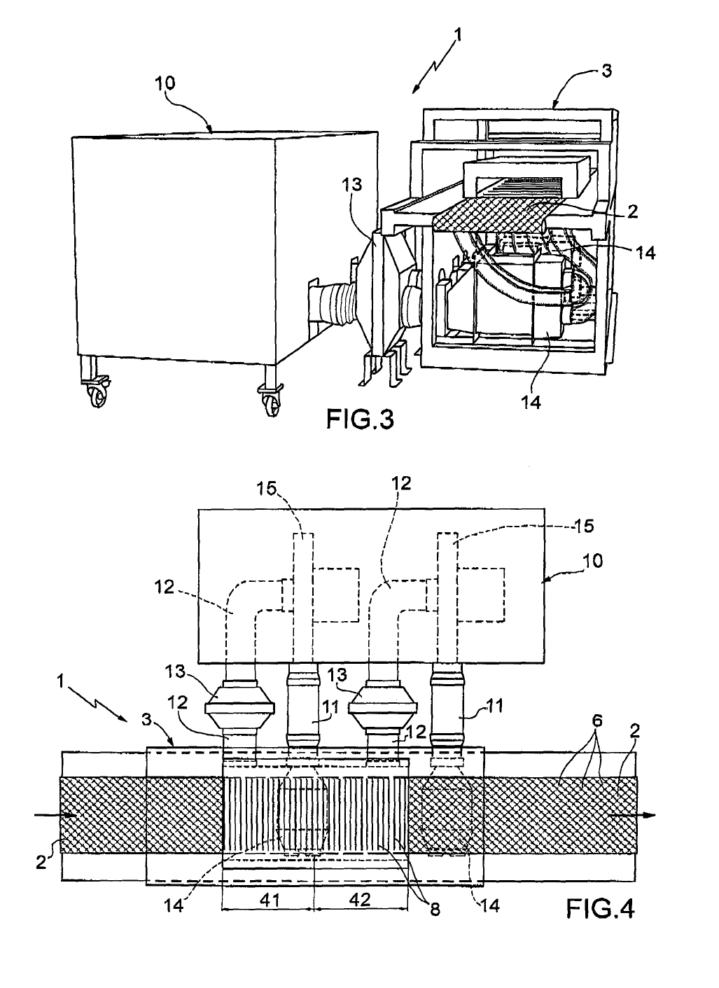

The apparatus 1 also comprises a ventilation and conditioning unit 10 (FIGS. 3 and 4) which provides air for treating the loose products.

The means for applying electromagnetic radiation are intended to hit the loose products that are transported through the treatment chamber 4 by the conveyor belt 2 with electromagnetic radiations, such means for applying electromagnetic radiation are not described in detail since they are not part of the present invention.

The conveyor belt 2 has a series of holes or openings 6—see in particular FIG. 4—which allow the passage of an air flow.

According to what is illustrated more in detail in FIG. 2, at the treatment chamber 4 the plane for supporting the conveyor belt 2 and the loose products being treated has a series of first openings 8.

An air flow, which can be suitably humidified so as to counteract the excessive drying of the products that are being treated, is sent throughout such first openings 8.

At the sides of the conveyor belt 2, second openings 9 for recovering the flow of air coming from the first openings 8 are provided, thus creating a circulation of air that can be heated and humidified according to the treatment needs of the loose products.

In order to better maintain the treatment conditions, the treatment chamber 4 is provided with walls 7 made of heat insulating material, which material is transparent to the electromagnetic radiations and, according to the case, transparent to microwaves, such a material can be for example of the expanded polymer type that is suitable for the purpose.

The ventilation and conditioning unit 10 that provides the flow of heated and humidified air comprises one or more fans, for example centrifugal fans 15, which are suitably actuated by motor means. More in detail, according to what is illustrated in FIGS. 3 and 4, the ventilation and conditioning unit 10 and the treatment unit 3 are connected by delivery lines 11 that send air to the first openings 8 in the treatment chamber 4 and by suction lines 12 that suck air throughout the second openings 9.

Between the ventilation and conditioning unit 10 and the treatment unit 3 air filters 13 of the replaceable and/or washable type are provided, which are designed to clean the flow of air for the treatment chamber 4, such filters being for example positioned on the suction line 12, but they could also be positioned on the delivery line 11.

The apparatus 1 comprises heat exchangers 14 that are in a position close to the loose products to be treated so as to avoid heat losses, for such a reason the heat exchangers 14 are positioned below the resting plane for the conveyor belt 2 and the loose products to be treated.

Downstream of the heat exchangers 14, humidifying means (not illustrated) for humidifying the air for the loose products are furthermore provided, such humidifying means can comprise for example ejectors that are in fluid communication with a steam generator component.

The humidification of the loose products to be treated can also be preliminarily obtained through water spraying means 16 arranged upstream of the treatment chamber 4 (FIG. 2) or throughout the treatment of the products (not illustrated).

In this case, being the water is in a hot and subjected to electromagnetic radiations and/or microwaves environment, it rapidly vaporises providing the desired level of humidity.

The ventilation and conditioning unit 10 checks the desired humidity level through measuring means, for example sensors (not illustrated), positioned at the inlet of the suction lines 12.

If the humidity level is too high the fans 15 can suck air from outside, having a lower humidity level, instead of from the treatment chamber 4. Moreover, air extraction means 18 (FIG. 1) that are directly arranged on the treatment unit 3 can be provided. The air extraction means 18 suck humid air from the treatment unit 3, and therefore from the treatment chamber 4, and consequently air with lower humidity is suctioned from the external environment. All or at least the most important regulator means of the thermo-hygro conditions of the loose products to be treated, i.e. fans 15, heat exchangers 14, humidifying means, water spraying means 16, air extraction means 18, etc., can be controlled by a control unit (not illustrated), designed to receive input signals from the measuring means and control, in output, the regulator means according to suitable programs.

The measuring means and the regulator means therefore ensure the control of the thermo-hygro conditions of the products to be treated.

According to the present invention the treatment chamber 4 comprises a first area 41 (FIG. 4) in which the loose products are subjected to electromagnetic radiation and/or to microwaves, thereby progressively raising the temperature and humidity according to a determined temperature/humidity—time curve.

As an example and according to the type of product to be treated, the achievement of the foreseen temperature and humidity conditions can be obtained in a time ranging between 1 and 10 minutes, starting from room temperature and up to a temperature between 50° C. and 120° C., as a function of the type of treatment (disinfestation, sanitization, pasteurisation, sterilisation, etcetera) and with levels of relative humidity between 10% and 95%.

The achievement of the foreseen temperature in the time required for the type of treatment foreseen, is due to the combination of electromagnetic radiation and/or microwaves and air heated with the necessary levels of radiating power and heat power.

According to the present invention, the treatment chamber 4 can optionally comprise a second holding area 42, wherein the loose products are held at the temperature and humidity conditions previously reached in the first area 41 and for a time interval similar to that of the treatment in the first area 41, i.e. ranging for example between 1 and 10 minutes.

In the second area 42, the holding of the temperature and humidity conditions previously reached can also be obtained without the electromagnetic radiation and/or microwaves, i.e. the loose products can be subjected only to the heated and/or humidified air flow.

The second holding area 42 with the foreseen temperature-humidity conditions can be very important in order to obtain the desired disinfestation, sanitization, pasteurisation, sterilisation effect to ensure that all infesting species and/or bacteria and/or microorganisms, etcetera, are killed because in the required cases it is indeed the extension for a certain period of time at the foreseen temperature and humidity conditions that ensures that 100% of the aforementioned infesting species, and/or bacteria, and/or microorganisms are killed.

Another important feature of the apparatus 1 is that of comprising mixing means for the loose products to be treated.

It should be noted that the heating provided by the electromagnetic radiations and/or microwaves, and also by the hot air, depends upon the orientation and upon the specific position of the products themselves inside the treated mass, and therefore they must be as mixed as possible in order to obtain a homogeneous heating and humidification in all of the loose products passing on the conveyor belt 2.

The mixing means can comprise mixer arms (not illustrated) that are arranged in the treatment chamber 4, or vibrating means (not illustrated) that are applied to the conveyor belt 2, or deviator means (not illustrated) that are arranged above the conveyor belt 2, or also the flow of heating air that passes throughout the conveyor belt 2, with suitable flow rate and pressure levels, can carry out a sufficient mixing of the loose products to be treated; moreover, a combination of one or more of the above-mentioned devices can be provided.

FIGS. 5-8 show another variant of the apparatus according to the present invention wholly indicated with reference numeral 101.

According to this variant too, the apparatus 101 essentially comprises means 102 for transporting the loose products, a unit 103 for treating the loose products, an area 104 for treating the loose products, means 105 for generating radio frequency electromagnetic radiations and/or microwaves and means for applying radio frequency electromagnetic radiations and/or microwaves (not illustrated).

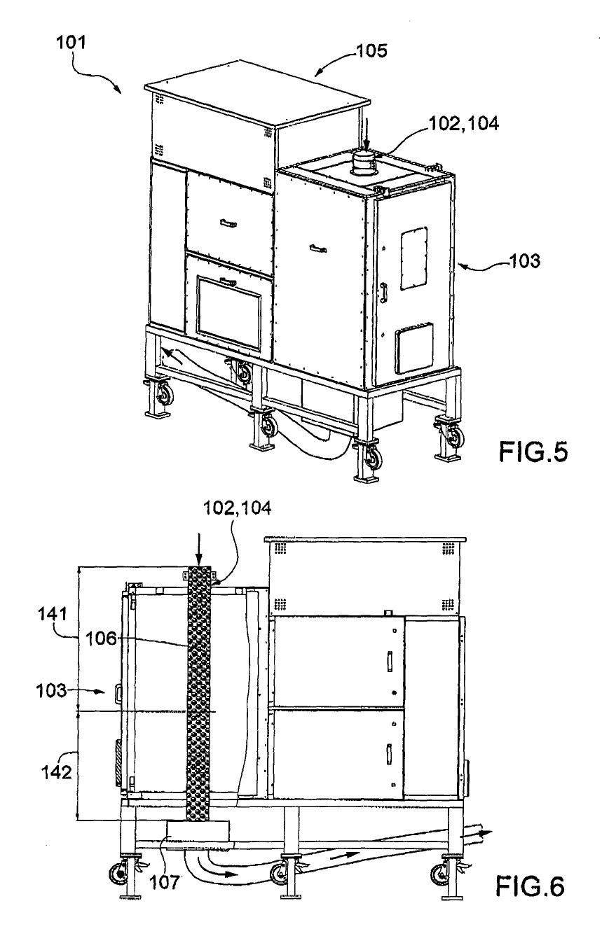

According to the variant shown in FIG. 6, the transporting means comprise a tube, for example a vertically arranged cylindrical tube 102 in which the loose products, here indicated with the number 106, move downwards due to the force of gravity or through other mechanical conveying systems.

The cylindrical tube 102 is made from heat insulating material and is transparent to the electromagnetic radiations and/or to the microwaves and thus constitutes also a treatment area or chamber 104.

The loose products 106 are introduced from above, through suitable introduction means (not illustrated), for example a hopper, and come out from the lower part of the tube through flow regulator means 107, for example a rotary valve, which make it possible to adjust the speed, or the volumetric or mass flow rate, of fall and therefore the moving forward of the loose products 106.

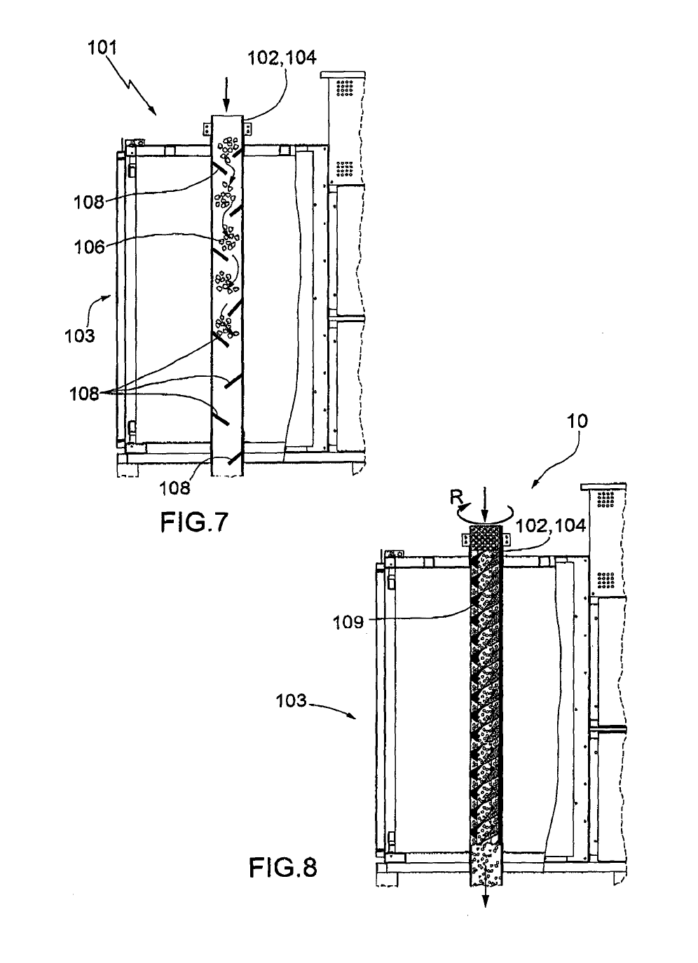

In the variant shown in FIG. 7, oblique baffles 108 can be provided, which have the function of mixing means of the loose products 106, since they prevent the compression and the formation of agglomerations in the loose products 106 themselves.

In the variant shown in FIG. 8, the mixing function of the loose products 106 is obtained by means of a screw or Archimedean screw 109, which is rotated according to the arrow R and makes it possible for there to be a controlled downwards advancing of the loose products 106.

Also according to this variant of the invention, the apparatus 101 can comprise a ventilation and conditioning unit 10 for supplying a flow of heated and humidified air that is introduced into the tube 102 from below thereof and rises upwards in counter-current with respect to the forward movement of the products 106, this flow can also act as mixing means.

According to another variant of the present invention, since the tube 102 is relatively small and is well insulated, the electromagnetic radiations and/or microwaves only can be sufficient to reach the desired level of temperature necessary for the type of treatment and therefore the apparatus 101 can also be lacking the ventilation and conditioning unit 10. As far as the level of humidity to be obtained is concerned, the level of humidity emitted by the loose products 106 themselves can be sufficient because the tube 102 represents a sufficiently confined area from which the humidity cannot easily escape.

Moreover, the humidification of the loose products 106 to be treated can also be preliminarily obtained by means of water sprinkling means (not illustrated) that are arranged close to the inlet of the tube 102.

Also in this variant of the invention, the tube 102, i.e. the treatment chamber 104 comprises a first area 141 (FIG. 6) in which the loose products are subjected to electromagnetic radiation and/or to microwaves, progressively raising the temperature and humidity according to a determined temperature/humidity—time curve.

Moreover, the tube 102 or treatment chamber 104 can optionally comprise a second holding area 142, in which the loose products 106 are held at the temperature and humidity conditions that were previously reached in the first area 141 and for a time similar to that of the treatment of the first area 141; also in this variant of the present invention such a second holding area 142 can be lacking the radio frequency electromagnetic radiations and/or microwaves.

A method for the drying and sanitization of loose products according to the present invention provides for conveying the loose products in at least one treatment chamber or area, for example the chamber 4, 104 through transporting means 2, 102, 109 and then applying radio frequency electromagnetic radiations and/or microwaves in the treatment chamber or area thereby affecting the loose product.

In the treatment chamber and in addition to the step of applying electromagnetic radiations, it is provided a heating step by means of hot air and a humidification step of the loose products. During the heating and humidification steps of the loose products it is also provided a mixing step of the loose products in order to obtain a homogeneous heating and humidification of all loose products.

As it will be understood, in a method and in an apparatus according to the present invention, the electromagnetic radiations, the hot air and the steam synergically contribute to the treatment of the loose food products.

Moreover, the possibility of optionally having a second holding area, wherein the loose products are held at the temperature and humidity conditions previously reached, ensures in the required cases that all species of infesting agents and/or bacteria, and/or microorganisms, etc. are completely killed.

Modifications and variants of the invention are possible within the protection defined by the claims.

1. An apparatus for drying and/or treating loose products including food products, the treatment that said loose products can be subjected to being of the type including disinfestation, sanitization, pasteurisation and sterilization, the apparatus comprising:
at least one conveying means of said loose products;
at least one treatment unit defining at least one treatment chamber or area;
means for generating radio frequency electromagnetic radiations;
means for applying radio frequency electromagnetic radiations and/or microwaves that act in said treatment chamber or area in electrical communication with said generator means and designed to engage said loose products transported through said at least one treatment chamber or area by said conveying means;
wherein said apparatus comprises
mixing means for the loose products to be treated arranged in said at least one treatment chamber or area.

2. The apparatus according to claim 1, wherein said mixing means for the loose products to be treated comprise at least one of mixer arms arranged in the treatment chamber, vibrating means applied to said conveying means, deviator means arranged above said conveying means, means for generating an air flow, with suitable levels of flow rate and pressure, which hits said products to be treated, oblique baffles, a screw or Archimedean screw.

3. The apparatus according to claim 1, comprising a ventilation and conditioning unit that supplies a flow of heated and humidified air into said treatment chamber or area.

4. The apparatus according to claim 3, wherein said ventilation and conditioning unit comprises means for regulating the temperature and humidity of the heated and humidified air.

5. The apparatus according to claim 4, comprising at least one control unit intended to receive, in input, temperature and humidity signals from measuring means and to control said regulating means during the application of said electromagnetic radiations to said loose products.

6. The apparatus according to claim 4, wherein regulating means comprise at least one fan intended to feed hot air throughout said loose products.

7. The apparatus according to claim 1, wherein said at least one conveying means has through openings and wherein in said chamber first openings are provided, and a flow of heated and humidified air passes throughout said openings.

8. The apparatus according to claim 1, wherein in said chamber second openings are provided throughout which a flow of air is sucked.

9. The apparatus according to claim 8, comprising at least one fan the intake of which is in fluid communication with said second openings.

10. The apparatus according to claim 4, wherein said regulator means comprise at least one steam dispensing component, or means for spraying water on said loose products.

11. The apparatus according to claim 10, wherein said at least one steam dispensing component feeds steam into the air being delivered by said at least one fan.

12. The apparatus according to claim 1, comprising water spraying means (16) arranged upstream of the treatment chamber (4, 104) to directly wet the loose products (106) to be treated.

13. The apparatus according to claim 1, wherein said chamber comprises a first area in which said loose products are subjected to electromagnetic radiation and/or to microwaves, progressively raising the temperature and humidity according to a determined temperature/humidity—time curve.

14. The apparatus according to claim 13, wherein said chamber comprises a second holding area, in which the loose products are substantially held in the temperature and humidity conditions previously reached in the first area and for a time similar to that of the treatment of said first area.

15. A method for drying and/or treating loose products including food products, the treatment that loose products can be subjected to being of the type including disinfestation, sanitization, pasteurisation and sterilization, comprising the following steps:
conveying said loose products into at least one treatment chamber or area;
applying radio frequency electromagnetic radiations or microwaves in said at least one treatment chamber or area so as to engage said loose products; further comprising mixing said loose products to be treated arranged in said at least one treatment chamber or area.

16. The method according to claim 15, comprising injecting a flow of heated and/or humidified air into said treatment chamber or area.

17. The method according to claim 15, comprising sucking a flow of heated and/or humidified air from said treatment chamber or area.

18. The method according to claim 17, comprising measuring the temperature and/or humidity of the air taken in by said treatment chamber or area and regulating, during said step of applying electromagnetic radiations and/or microwaves, the temperature and/or humidity of the air injected into said treatment chamber or area.

19. The method according to claim 18, wherein said step of regulating the humidity in said treatment chamber or area comprises feeding steam, or spraying water, onto said loose products before entering into said treatment chamber or area.

20. The method according to claim 15, wherein said step of applying electromagnetic radiations and/or microwaves and heated and/or humidified air onto said loose products can determine a temperature from about 50° C. to about 120° C. and a relative humidity from about 10% to about 95%, for a time period from about 1 to about 10 minutes.
